(19) United States
(12) Patent Application Publication
(10) Pub. No.: US 2009/0238219 A1
(43) Pub. Date: Sep. 24, 2009

(54) OPTICAL MODULE

(75) Inventor: Kenichi Nakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/405,691

(22) Filed: Mar. 17, 2009

(30) Foreign Application Priority Data
Mar. 24, 2008 (JP) 2008-074955

(51) Int. Cl. H01S 3/10; H01S 3/04; H01S 3/13

(52) U.S. Cl. 372/20; 372/34; 372/29.021

(57) ABSTRACT

An optical module includes a semiconductor laser for output light with a wavelength, a temperature stabilization unit arranged for adjusting temperature of the semiconductor laser, and a controller for controlling a current injected to the semiconductor leaser by the use of a first function in accordance with changing of the wavelength on the bases of heat at the time of changing of the wavelength of the outputted light of the semiconductor leaser in a predetermined first period, and controlling the current injected to the semiconductor leaser by the use of a second function in accordance with changing of the wavelength on the bases of the temperature stabilization unit in a predetermined second period after the first period.

### CROSS-REFERENCE TO RELATED APPLICATIONS

This application is based upon and claims the benefit of priority of the prior Japanese Patent Application No. 2008-074955, filed on Mar. 24, 2008, the entire contents of which are incorporated herein by reference.

### FIELD

The embodiments discussed herein are related to an optical module including a semiconductor laser.

### BACKGROUND

As data traffic is increased in recent years, long-distance, high-speed, large-capacity communications are required. There have been constructed DWDM (Dense Wavelength Division Multiplexing) networks that are one of communication technologies using an optical fiber and in which an optical fiber is used in a multiplexed manner by using multiple optical signals of different wavelengths simultaneously. Toward the realization of larger-capacity transmission, it is desired to construct a next-generation photonic network for performing dynamic wavelength switching or wavelength routing.

In order to realize such a network, it is necessary to develop a wavelength tunable light source that is allowed to tune a variation in a wavelength at a high speed. A semiconductor laser (laser diode: LD) is typically used as a wavelength tunable light source.

While a temperature control-type wavelength tunable light source that changes the oscillation wavelength by controlling the temperature or a mechanical control-type wavelength tunable light source that changes the oscillation wavelength mechanically have relatively low response speeds, e.g., on the order of ms (millimeter sec), a current injection-type wavelength tunable light source that changes the oscillation wavelength by injecting a current has a response speed of the order of ns (nanometer sec) in principle. Therefore, a current injection-type wavelength tunable light source is preferably used as a wavelength tunable light source.

In particular, a TDA-DFB-LD (tunable distributed amplification distributed feed back laser diode) is a current injection-type wavelength tunable light source that illustrates excellent operations such as simplified wavelength control using a single injection current and no mode-hops (mode-hop-free). For example, see Japanese Laid-open Patent Publication No. 2006-295102.

However, in the case of a TDA-DFB-LD, the temperature of the LD is changed by heat caused due to the injection of a wavelength control current at the time of wavelength switching. As a result, a wavelength drift occurs.

FIGS. 20A-20C include graphs illustrating a cause of occurrence of a drift.

As illustrated in FIG. 20A, the current value of the injection current is changed from a current value ILD91 to a current value ILD92 at time t90.

As illustrated in FIG. 20B, a drift occurs due to heat caused by an increase in current value of the injection current. Thus, between time t90 and time t91, a temperature TLD of the wavelength tunable light source is changed from a temperature value TLD91 to a temperature value TLD92. Subsequently, between time t91 and time t92, the heat is reduced by the TEC and the temperature moves toward the stabilization. As illustrated in FIG. 20C, these have an influence on the drift of the wavelength.

A system having short wavelength intervals, such as DWDM, has a problem that this wavelength drift has a nonnegligible influence on an adjacent channel.

With regard to this problem, a technology is known for, in a wavelength tunable light source for feedback-controlling the LD current using a wavelength monitor, starting feedback control after the temperature is stabilized after a current is injected at the time of wavelength switching. For example, see Laid-open Patent Publication No. 2005-64300.

However, this method that waits for the temperature to be stabilized has a problem that it is difficult to perform wavelength switching at a high speed.

### SUMMARY

According to an aspect of the invention, an optical module includes a semiconductor laser for output light with a wavelength, a temperature stabilization unit arranged for adjusting temperature of the semiconductor laser, and a controller for controlling a current injected to the semiconductor leaser by the use of a first function in accordance with changing of the wavelength on the bases of heat at the time of changing of the wavelength of the outputted light of the semiconductor leaser in a predetermined first period, and controlling the current injected to the semiconductor leaser by the use of a second function in accordance with changing of the wavelength on the bases of the temperature stabilization unit in a predetermined second period after the first period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a graph illustrating an outline of the present invention.

FIG. 2 is a block diagram illustrating functions of an optical module.

FIG. 3 is a configuration of a TDA-DFB-LD.

FIG. 4 is a plan view illustrating a configuration of the TDA-DFB-LD.

FIGS. 5A and 5B include graphs illustrating a variation in a wavelength caused by a wavelength control current.

FIG. 6 is a flowchart illustrating a function calculation process in a first control method.

FIG. 7 is a flowchart illustrating a wavelength tuning process in the first control method.

FIGS. 8A-8D include graphs schematically illustrating a result of control performed using the first control method.

FIG. 9 is a drawing illustrating a table stored in a memory.

FIG. 10 is a graph illustrating a variation in a wavelength caused by the temperature of a gain control current.

FIG. 11 is a flowchart illustrating a function calculation process in a second control method.

FIG. 12 is a flowchart illustrating a wavelength tuning process in the second control method.

FIGS. 13A-13D include graphs schematically illustrating a result of control performed using the second control method.

FIG. 14 is a block diagram illustrating functions of a second embodiment.

FIG. 15 is a drawing illustrating a specific example of a shutter.

FIG. 16 is a flowchart illustrating a wavelength tuning process in a first control method according to the second embodiment.

FIGS. 17A-17C include graphs schematically illustrating a result of control performed using the first control method according to the second embodiment.

FIG. 18 is a flowchart illustrating a wavelength tuning process in a second control method according to the second embodiment.

FIGS. 19A-19D include graphs schematically illustrating a result of control performed using the second control method according to the second embodiment.

FIGS. 20A-20C include graphs illustrating a cause of occurrence of a drift.

### DESCRIPTION OF EMBODIMENTS

Now, embodiments will be described with reference to the accompanying drawings.

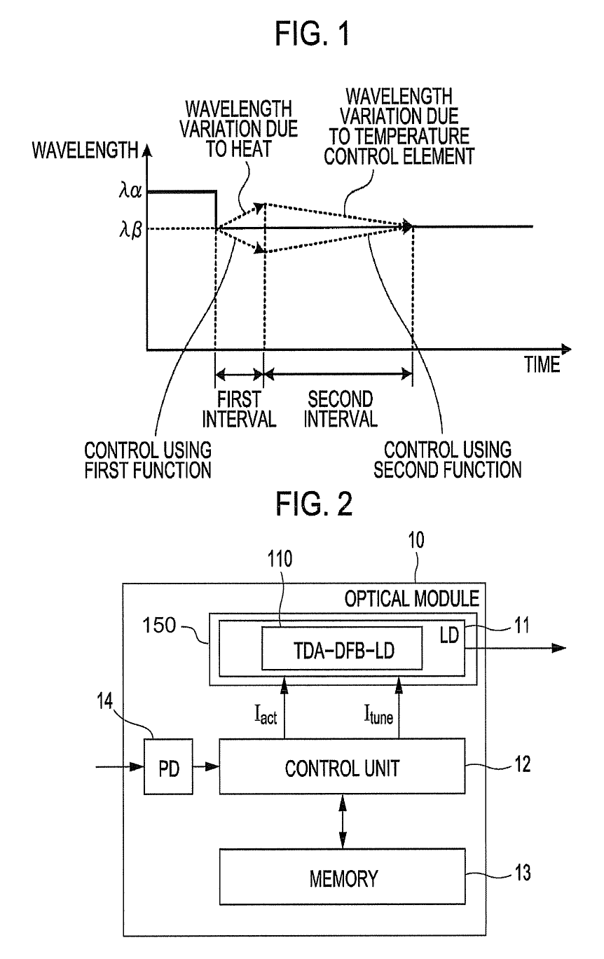

FIG. 1 is a graph illustrating an embodiment. When the wavelength of a semiconductor laser is switched from λα to λβ, a variation in the wavelength due to heat caused by the wavelength switching is controlled during a predetermined first interval, using a first function for determining a current to be injected to the semiconductor laser.

During a predetermined second interval, a variation in the wavelength caused by a temperature-control element for controlling the temperature of the semiconductor laser is controlled using a second function for determining a current to be injected to the semiconductor laser.

By using the above-mentioned semiconductor laser control method, the temperature of the semiconductor laser is changed by heat caused by the injection of a wavelength control current at the time of wavelength switching. This suppresses occurrence of a wavelength drift.

Hereafter, the embodiments will be described.

FIG. 2 is a block diagram illustrating functions of an optical module. An optical module 10 includes an LD 11, a control unit 12, a memory 13, and a PD (photo diode) 14.

The LD 11 includes a TDA-DFB-LD 110 as the wavelength tunable light source. The LD 11 is placed on a temperature stabilization unit 150 including a temperature-control element (e.g. thermoelectric cooler).

The control unit 12 includes a CPU (central processing unit). The control unit 12 has a timer function and outputs a wavelength control current Iₜᵤₙₑ (hereafter simply referred to as the “current Iₜᵤₙₑ”) and a gain control current I_{act} (hereafter simply referred to as the “current I_{act}”) to the LD 11 using a function (to be described later) in predetermined cycles so as to control the LD 11.

The memory 13 includes a ROM (read only memory). The memory 13 is storing various types of data necessary when the control unit 12 performs control.

A PD 14 detects an optical signal inputted from the outside and converts the optical signal into an electric signal.

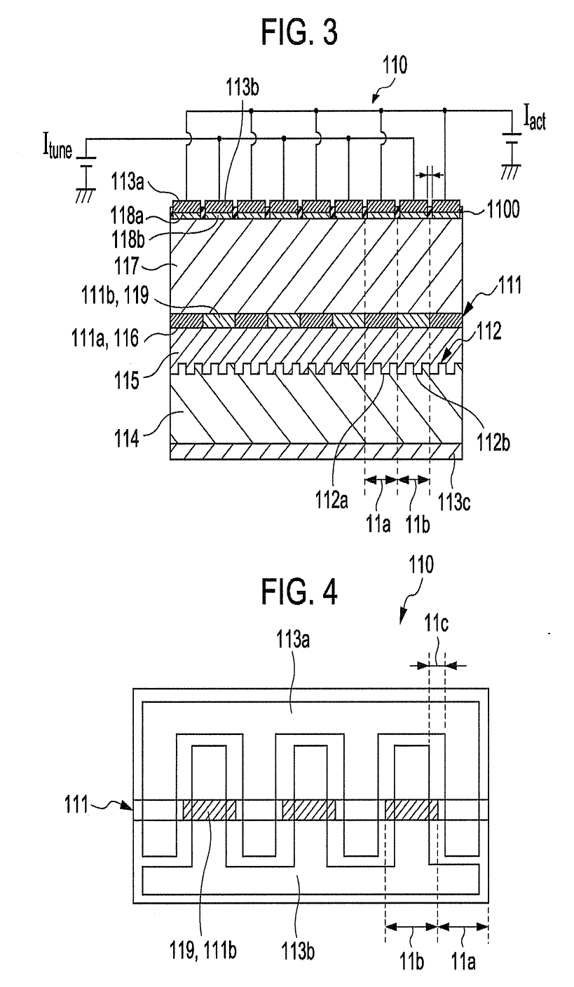

FIG. 3 is a sectional view illustrating a configuration of the TDA-DFB-LD and FIG. 4 is a plan view illustrating a configuration of the TDA-DFB-LD.

The TDA-DFB-LD 110 includes an optical waveguide (optical waveguide layer) 111 including a gain waveguide part (active waveguide unit) 111a that generates a gain due to the injection of the current I_{act} and a wavelength control waveguide part 111b that controls the oscillation wavelength using a variation in the index of refraction due to the injection of the current Iₜᵤₙₑ. The TDA-DFB-LD 110 also includes a diffraction grating (diffraction grating layer) 112 provided near the optical waveguide 111.

When the current I_{act} is injected into the gain waveguide part 111a, the TDA-DFB-LD 110 oscillates with a wavelength corresponding to the cycle of the diffraction grating 112. Also, when the current Iₜᵤₙₑ is injected into the wavelength control waveguide part 111b, the TDA-DFB-LD 110 controls the oscillation wavelength.

The optical waveguide 111 has a configuration in which gain waveguide units 111a and wavelength control waveguide units 111b are alternately provided. That is, the optical waveguide 111 includes multiple gain waveguide units 111a and multiple wavelength control waveguide units 111b and has a configuration in which the gain waveguide units 111a and wavelength control waveguide units 111b are alternately disposed on the same plane in series in cycles.

The diffraction grating 112 is provided below the optical waveguide 111 throughout the length of the optical waveguide 111 in parallel with the optical waveguide 111. In other words, the diffraction grating 112 is continuously formed in positions associated with the gain waveguide units 111a and in positions associated with the wavelength control waveguide units 111b. The diffraction grating 112 formed in the positions associated with the gain waveguide units 111a is referred to as a gain diffraction grating 112a. In addition, the diffraction grating 112 formed in the positions corresponding to the wavelength control waveguide units 111b is referred to as a wavelength control diffraction grating 112b.

Since the TDA-DFB-LD 110 is one type of DFB laser, it does not need to perform phase control when performing wavelength change control, unlike a DBR laser. Accordingly, the TDA-DFB-LD 110 is allowed to perform simple wavelength control using only the current Iₜᵤₙₑ. Since the diffraction grating 112 is provided throughout the length of the optical waveguide 111 in the TDA-DFB-LD 110, the TDA-DFB-LD 110 also does not need to perform initial phase control.

In the TDA-DFB-LD 110, the gain waveguide parts 111a of the optical waveguide 111 and wavelength control waveguide parts 111b thereof are independently provided with gain electrodes 113a forming P-side electrodes and wavelength control electrodes 113b forming P-side electrodes, respectively, so that currents are independently injected into the gain waveguide parts 111a and wavelength control waveguide parts 111b.

Specifically, a gain electrode 113a is formed above the upper surfaces of the gain waveguide parts 111a of the optical waveguide 111 with a contact layer 118a therebetween. A common electrode 113c forming an N-side electrode is formed below the gain waveguide parts 111a. Thus, the current I_{act} is injected into active layers (gain layers or waveguide core layers) 116 of the gain waveguide parts 111a. Also, a wavelength control electrode 113b is formed above the upper surfaces of the wavelength control waveguide parts 111b of the optical waveguide 111 with a contact layer 118b therebetween. The common electrode 113c is formed below the wavelength control waveguide parts 111b. Thus, the current Iₜᵤₙₑ is injected into wavelength control layers 119 of the wavelength control waveguide parts 111b.

As illustrated in FIG. 4, the gain electrode 113a and wavelength control electrode 113b are each formed as a comb-shaped electrode.

An area made up of each gain waveguide part 111a, gain diffraction grating 112a, gain electrode 113a, and common electrode 113c is referred to as a gain area 11a. An area made up of each wavelength control waveguide part 111b, wavelength control diffraction grating 112b, wavelength control electrode 113b, and common electrode 113c is referred to as a wavelength control area 11b.

As is understood from the above description, each gain area 11a has a layer structure in which an n-InP layer 114, the diffraction grating 112, an n-type InP layer 115, each active layer 116, a p-InP layer 117, and the contact layer 118a are sequentially stacked in layers.

Also, each wavelength control area 11b has a layer structure in which the n-InP layer 114, diffraction grating 112, n-InP layer 115, wavelength control layer 119, p-InP layer 117, and contact layer 118a are sequentially stacked in layers.

A SiO2 film (Passivation Film) 1100 is formed in an area in which none of the contact layers 118a and 118b, wavelength control electrode 113b, and gain electrode 113a is formed. Specifically, by forming the contact layers 118a and 118b, then forming the SiO2 film 1100 on all surfaces of these layers, and then eliminating only the SiO2 film 1100 formed on these layers so as to form the gain electrode 113a and wavelength control electrode 113b on the contact layers 118a and 118b, the SiO2 film 1100 is formed in an area in which none of the gain electrode 113a and wavelength control electrode 113b is formed.

In particular, as illustrated in FIGS. 3 and 4, in order to electrically separate the gain areas 11a and wavelength control areas 11b, separation areas 11c are provided between the gain electrode 113a and wavelength control electrode 113b. That is, by avoiding formation of the wavelength control electrode 113b, gain electrode 113a, and contact layers 118a and 118b in an area above the vicinity of the bonding interface between each gain area 11a and wavelength control area 11b, each separation area 11c is formed.

First Control Method:

Hereafter, a first method for controlling the optical module 10 will be described.

The first control method is a method in which the drift of the wavelength due to an increase in temperature of the LD11 is suppressed by temporally controlling the current Iₜᵤₙₑ using the control unit 12 after the injection of the current Iₜᵤₙₑ when the LD11 performs wavelength switching (at the time of wavelength switching).

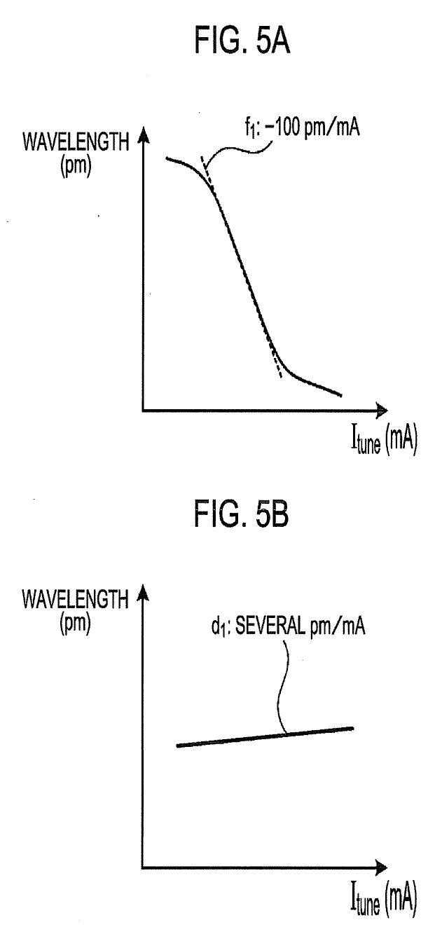

FIGS. 5A and 5B include graphs illustrating a variation in the wavelength caused by a wavelength control current. FIG. 5A is a graph illustrating a variation in the wavelength due to a carrier plasma effect of a wavelength control current and FIG. 5B is a graph illustrating a variation in the wavelength caused by the temperature of a wavelength control current.

As illustrated in FIG. 5A, a variation value h of the wavelength due to a carrier plasma effect of the current Iₜᵤₙₑ is on the order of −100 pm/mA in an area whose inclination is approximately constant.

In addition, as illustrated in FIG. 5B, a variation value d₁ of the wavelength caused by the current value of the current Iₜᵤₙₑ is on the order of several pm/mA. This is a variation of the temperature caused by an increase or a decrease in the current value.

Next, a function calculation process performed by the control unit 12 in given cycles when performing control using the first control method will be described.

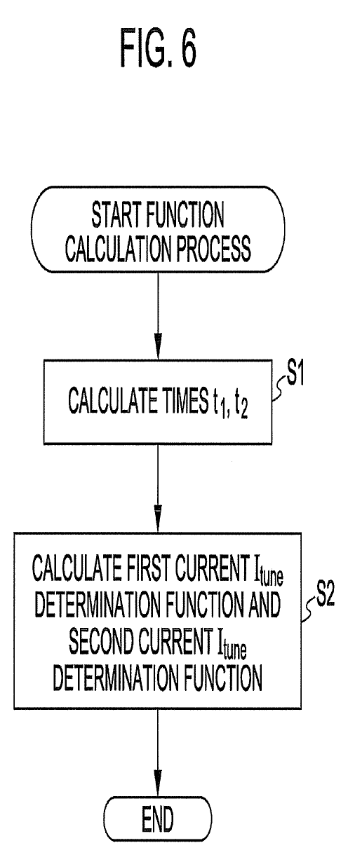

FIG. 6 is a flowchart illustrating a function calculation process in the first control method.

First, times t₁ and t₂ are calculated from a thermal response characteristic demonstrated when the current Iₜᵤₙₑ is injected, and the calculated times t₁ and t₂ are stored in the memory 13 (step S1). Time t₂ is set to, for example, the order of seconds so that a response is made to a heat reduction by the TEC.

Next, a first current Iₜᵤₙₑ determination function for determining the current value of the current Iₜᵤₙₑ between times t₀ and t₁ and a second current Iₜᵤₙₑ determination function for determining the current value of the current Iₜᵤₙₑ between times t₁ and t₂ are determined using times t₁ and t₂, the variation value d₁ and a variation value f₁, and a difference value (Iₜ₂−Iₜ₁) between current values Iₜ₂ and Iₜ₁ indicating injection amounts of the current Iₜᵤₙₑ (step S2).

The first current Iₜᵤₙₑ determination function is represented by Formula 1 below and the second current Iₜᵤₙₑ determination function is represented by Formula 2 below.

Iₜᵤₙₑ=−d₁×(Iₜ₂−Iₜ₁)/(f₁×ₜ₁)×t+Iₜ₂ (1)

Iₜᵤₙₑ=d₁×(Iₜ₂−Iₜ₁)/(f₁×(t₂−t₁))×t+Iₜ₂−dI×t₂(Iₜ₂−Iₜ₁)/(f₁×(t₂−t₁)) (2)

As is understood from the above description, the first current Iₜᵤₙₑ determination function and second current Iₜᵤₙₑ determination function are a function taking into account a variation due to a carrier plasma effect of the current Iₜᵤₙₑ and a function taking into account a variation due to the temperature of the current Iₜᵤₙₑ, respectively.

This completes the function calculation process in the first control method.

Next, a wavelength tuning process in the first control method will be described.

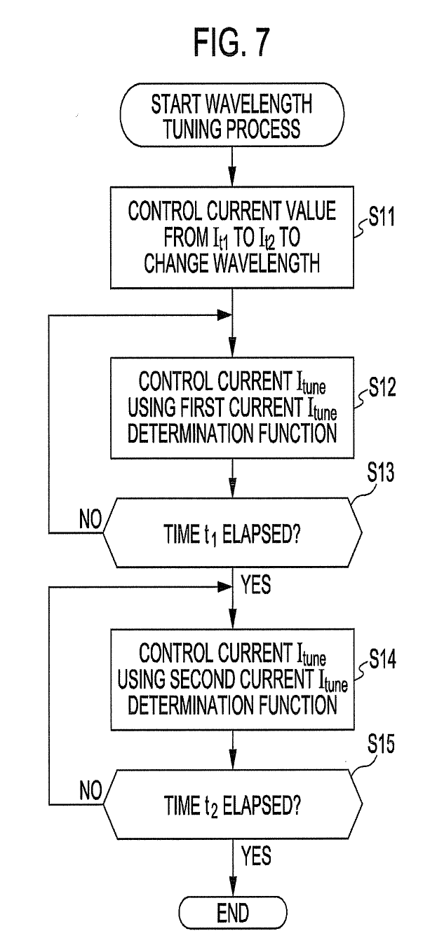

FIG. 7 is a flowchart illustrating the wavelength tuning process in the first control method.

The current Iₜᵤₙₑ is controlled from the current value Iₜ₁ to the current value Iₜ₂ so as to change the wavelength (step S11).

Next, the current Iₜᵤₙₑ is controlled using the first current Iₜᵤₙₑ determination function calculated in step S2 of FIG. 6 (step S12).

Next, whether time to has elapsed is determined (step S13).

If time t1 has not elapsed (No in step S13), the wavelength tuning process moves to step S12 and the process in step S12 is performed again.

On the other hand, if t1 has elapsed (Yes in step 13), the current Iₜᵤₙₑ is controlled using the second current Iₜᵤₙₑ determination function calculated in step S2 of FIG. 6 (step S14).

Next, whether time t₂ has elapsed is determined (step S15).

If time t₂ has not elapsed (No in step S15), the wavelength tuning process moves to step S14 and the process in step S14 is performed again.

On the other hand, if t₂ has elapsed (Yes in step 15), the wavelength tuning process is completed.

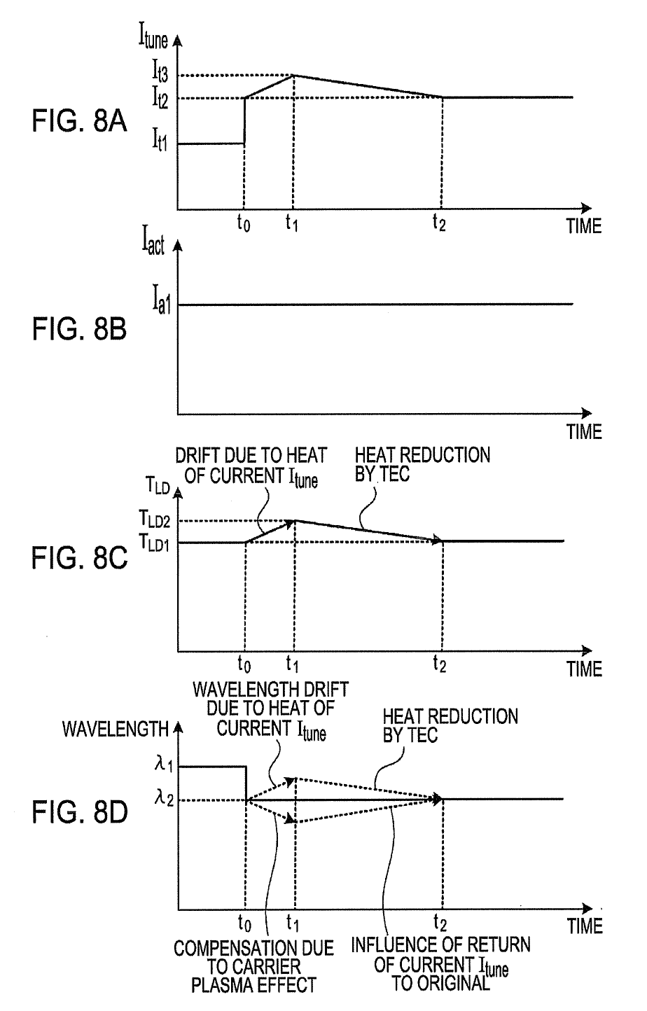

FIGS. 8A-8D include graphs schematically illustrating a result of control performed using the first control method.

As illustrated in FIG. 8A, when the wavelength is changed, the control unit 12 performs control at time t₀ so that the current value of the current Iₜᵤₙₑ is changed from the current value Iₜ₁ to the current value Iₜ₂, which is larger than the current value Iₜ₁.

Between time t₀ and time t1, the control unit 12 performs control so that the current Iₜᵤₙₑ is changed from the current value Iₜ₂ to the current value Iₜ₃ at the maximum using the first current Iₜᵤₙₑ determination function.

Subsequently, between time t1 and time t₂, the control unit 12 performs control so that the current Iₜᵤₙₑ is changed from the current value Iₜ₃ to the current value Iₜ₂ using the second current Iₜᵤₙₑ determination function. Note that, as illustrated in FIG. 8B, the current I_{act} is kept constant at a current value Iₐ₁ in the first control method.

As illustrated in FIG. 8C, between time t₀ and time t1, a drift occurs due to heat caused by an increase in the current value of the current Iₜᵤₙₑ. Thus, the temperature TLD of the LD11 is changed from a temperature value T_{LD1} to a temperature value T_{LD2}. Subsequently, between time t1 and time t₂, the heat is reduced by the TEC and the temperature moves toward the stabilization. These have an influence on the drift of the wavelength.

As a result, as illustrated in FIG. 8D, compensation taking into account a variation caused by a carrier plasma effect is made for a drift caused by a variation in the temperature by using the first current Iₜᵤₙₑ determination function between time t₀ and time t1. Thus, a wavelength λ2 is kept constant. Also, between time t1 and time t₂, compensation taking into account a heat reduction caused by the TEC is made for the drift by using the second current Iₜᵤₙₑ determination function. Thus, the wavelength λ2 is kept constant. After time t₂ elapses, the compensation using the second current Iₜᵤₙₑ determination function is cancelled.

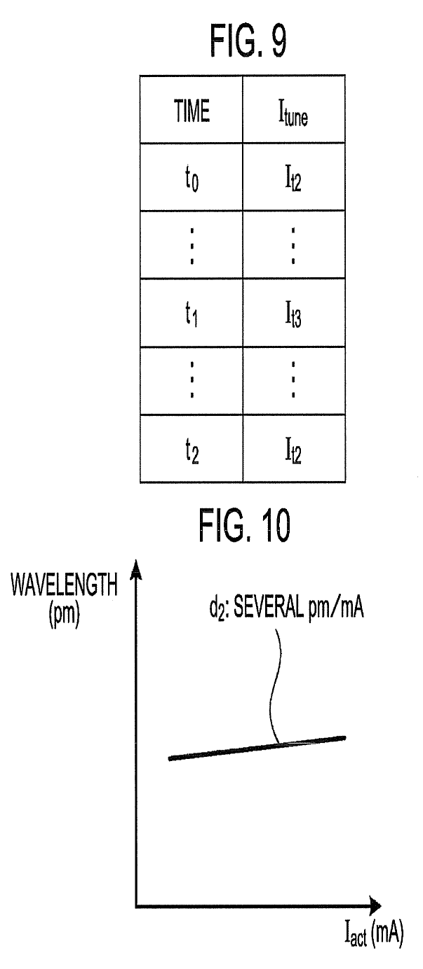

FIG. 9 is a drawing illustrating a table stored in a memory.

In each of steps 12 and 14 of the wavelength tuning process in this control method, the current value of the current Iₜᵤₙₑ is calculated on the basis of the function calculated in the function calculation process; however, the relations between the times and the current values of the current Iₜᵤₙₑ may be stored in the form of a table in the memory 13 and the values may be read out.

Second Control Method:

Hereafter, a second method for controlling the optical module 10 will be described.

The second control method is a method of keeping the temperature TLD constant and thus suppressing the drift of the wavelength by controlling the current I_{act} after the injection of the current Iₜᵤₙₑ at the time of wavelength switching so as to keep constant the total calorie of the current Iₜᵤₙₑ and current I_{act}.

FIG. 10 is a graph illustrating a variation in the wavelength caused by the temperature of a gain control current.

A variation value d₂ of the wavelength caused by the current value of the current I_{act} is on the order of several pm/mA.

While a function is calculated by performing a function calculation process also in the second control method, the formula for the calculation is different from that in the first control method.

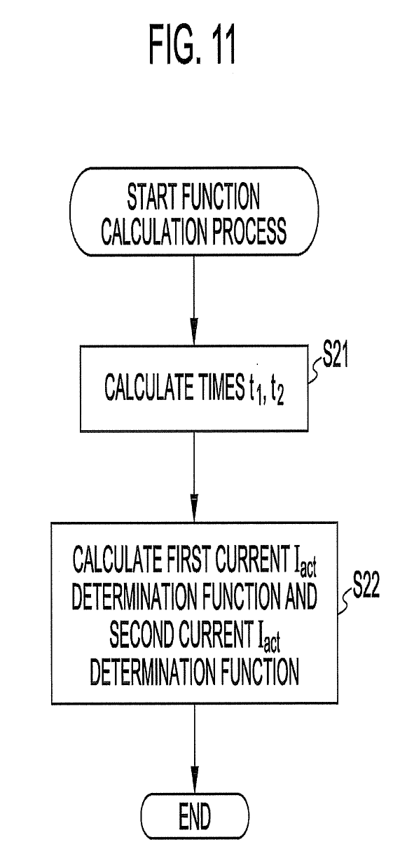

FIG. 11 is a flowchart illustrating a function calculation process in the second control method.

First, like in the first control method, times t₁ and t₂ are calculated from a thermal response characteristic demonstrated when the current Iₜᵤₙₑ is injected, and the calculated times t₁ and t₂ are stored in the memory 13 (step S21).

Next, a first current I_{act} determination function for determining the current value of the current I_{act} between times t₀ and t1 and a second current I_{act} determination function for determining the current value of the current I_{act} between times t1 and t₂ and are determined using times t1 and t₂, the variation values d₁ and d₂, the current value Iₐ₁ of the current I_{act} before the wavelength switching, and the difference value (Iₜ₂−Iₜ₁) between the current values Iₜ₂ and Iₜ₁ indicating injection amounts of the current Iₜᵤₙₑ (step S22). The first current I_{act} determination function is represented by Formula 3 below and the second current I_{act} determination function is represented by Formula 4 below.

I_{act}=Iₐ₁−d₁×(Iₜ₂−Iₜ₁)/d₂ (3)

I_{act}=d₁×(Iₜ₂−Iₜ₁)/(d₂×(t₂−t₁))×t+Iₐ₁−d₁×t₂(Iₜ₂−Iₜ₁)/(d₂×(t₂−t₁)) (4)

As is understood from the above description, the first current I_{act} determination function and second current I_{act} determination function are a function taking account a variation due to the temperature of the current I_{act} and a function taking into account a variation due to the temperature of the current Iₜᵤₙₑ, respectively.

This completes the function calculation process in the second control method.

Next, a wavelength tuning process in the second control method will be described.

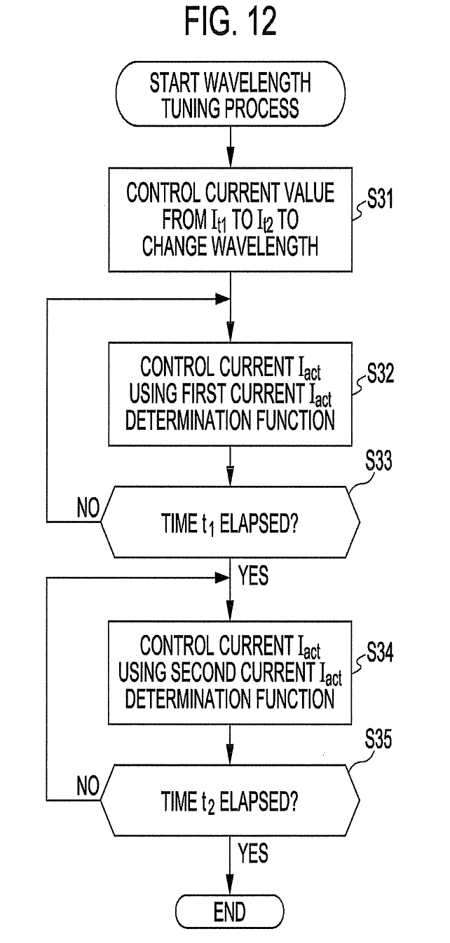

FIG. 12 is a flowchart illustrating the wavelength tuning process in the second control method.

First, the current Iₜᵤₙₑ is controlled from the current value Iₜ₁ to the current value Iₜ₂ to change the wavelength (step S31).

Next, the current I_{act} is controlled using the first current I_{act} determination function calculated in step S22 (step S32).

Next, whether time to has elapsed is determined (step S33).

If time t1 has not elapsed (No in step S33), the wavelength tuning process moves to step S32 and the process in step S32 is performed again.

On the other hand, if time t1 has elapsed (Yes in step 33), the current I_{act} is controlled using the second current I_{act} determination function calculated in step S22 (step S34).

Next, whether time t₂ has elapsed is determined (step S35).

If time t₂ has not elapsed (No in step S35), the wavelength tuning process moves to step S34 and the process in step S34 is performed again.

On the other hand, if time t₂ has elapsed (Yes in step 35), the wavelength tuning process is completed.

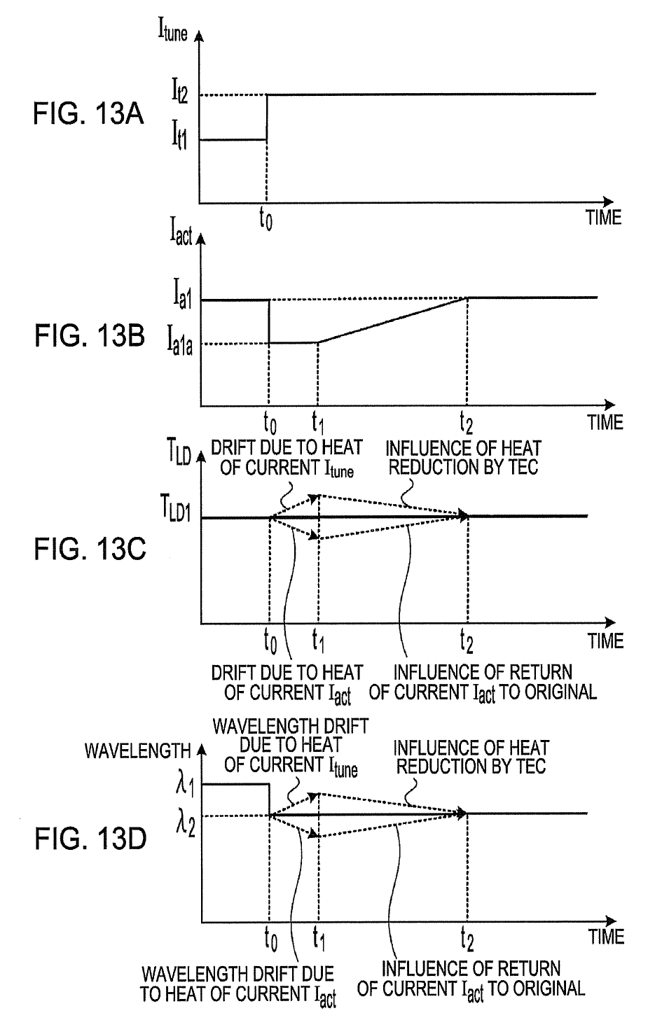

FIGS. 13A-13D include graphs schematically illustrating a result of control performed using the second control method.

As illustrated in FIG. 13A, the control unit 12 performs control at time t₀ so that the current value of the current Iₜᵤₙₑ is changed from the current value Iₜ₁ to the current value Iₜ₂.

As illustrated in FIG. 13B, between time t₀ and time t₁, the control unit 12 performs control using the first current I_{act} determination function so that the current I_{act} is changed from the current value Iₐ₁ to a current value Iₐ₁ₐ.

Subsequently, between time t₁ and time t₂, the control unit 12 performs control using the second current I_{act} determination function so that the current I_{act} is changed from the current value Iₐ₁ₐ to the current value Iₐ₁.

As illustrated in FIG. 13C, between time t₀ and time t₁, a drift caused by the heat of the current Iₜᵤₙₑ and an increase in temperature of the LD 11 from the temperature value T_{LD1} are compensated for by performing control using the first current I_{act} determination function, that is, by performing control so that a drift occurs due to the heat of the current I_{act} and the temperature of the LD11 is lowered from the temperature value T_{LD1}. Subsequently, between time t₁ and time t₂, compensation is made with respect to an area influenced by a heat reduction caused by the TEC, by performing control using the second current I_{act} determination function.

As a result, the temperature TLD is kept at the temperature value T_{LD1} and, as illustrated in FIG. 13D, the wavelength λ2 is kept constant.

Also, in the wavelength tuning process in this control method, the relations between the times and the current values of the current I_{act} may be stored in the form of a table in the memory 13 and the values may be read out, like in the first control method.

As described above, if the optical module 10 is used, the drift of the wavelength due to the temperature of the LD 11 is suppressed by temporally controlling the current Iₜᵤₙₑ or the current I_{act} after the injection of the current Iₜᵤₙₑ at the time of wavelength switching. As a result, switching is performed at a high speed.

Next, an optical module according to the second embodiment will be described.

Hereafter, the optical module according to the second embodiment will be described while focusing on differences between the optical module according to the second embodiment and the optical module 10 according to the first embodiment and same items will not be described.

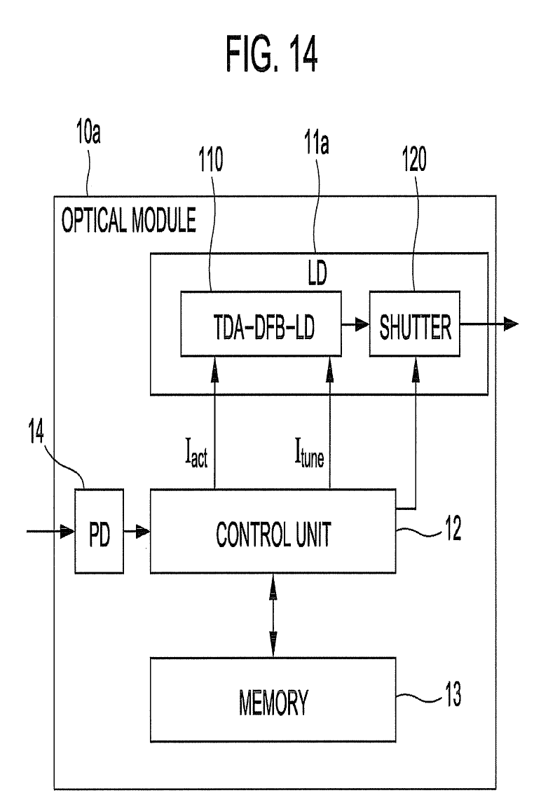

FIG. 14 is a block diagram illustrating functions of the second embodiment.

An LD 11a of an optical module 10a according to the second embodiment illustrated in FIG. 14 includes a shutter 120 having a function of shutting off an optical signal outputted from the TDA-DFB-LD 110.

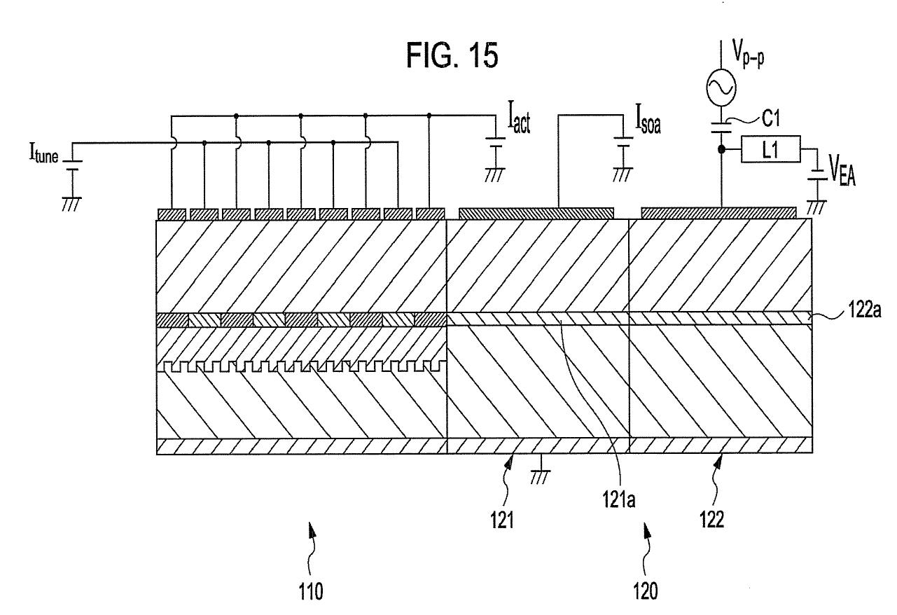

FIG. 15 is a drawing illustrating a specific example of a shutter.

The shutter 120 includes a SOA (semiconductor optical amplifier) 121 and an EA (elector absorption) modulator 122.

An integrated circuit of the TDA-DFB-LD 110, SOA 121, and EA modulator 122 constitutes the main part of a TDA-EML (tunable distributed amplification electro absorption modulated laser). By configuring a TDA-EML as described above, the optical module 10a is downsized.

The SOA 121 includes an amplification layer 121a for amplifying an optical signal outputted from the TDA-DFB-LD 110 when a current Iₛₒₐ is injected.

The SOA 121 serves as a shutter for shutting off the output of an optical signal outputted from the TDA-DFB-LD 110 when a SOA voltage (Vsoa) is set to 0V and outputting an optical signal when the current Iₛₒₐ is added to the SOA 121.

The EA modulator 122 includes an absorption layer 122a for absorbing an optical signal outputted from the SOA 121 when a modulation signal Vp-p is applied. The EA modulator 122 is provided with a power supply for applying a bias voltage VEA and a capacitor C1 and an inductor L1 for preventing entry of a modulation signal to the power supply.

The EA modulator 122 performs as a shutter for shutting off the output of an optical signal outputted from the TDA-DFB-LD 110 when the bias voltage VEA voltage is applied for outputting an optical signal and when the applied the bias voltage VEA voltage is cancelled for shut off the optical signal.

The time during which the shutter shuts off the output of an optical signal is on the order of several ns.

Shutter control is realized, for example, by making an interrupt when the CPU included in the control unit 12 is performing processing.

First Control Method:

Hereafter, a first method for controlling the optical module 10a will be described.

A function calculation process in the first method for controlling the optical module 10a is similar to the function calculation process in the first control method according to the first embodiment.

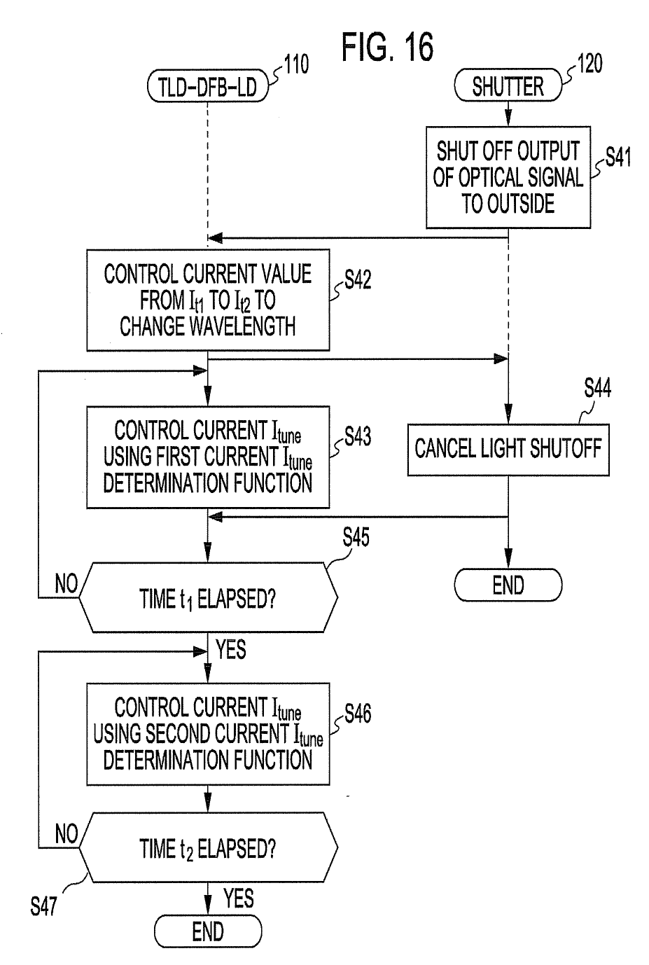

FIG. 16 is a flowchart illustrating a wavelength tuning process in the first method for controlling an optical module according to the second embodiment.

First, the output of an optical signal to the outside is shut off by controlling the shutter 120 (step S41).

The current Iₜᵤₙₑ is controlled from the current value Iₜ₁ to the current value Iₜ₂ to change the wavelength (step S42).

Next, the current Iₜᵤₙₑ is controlled using the first current Iₜᵤₙₑ determination function calculated in step S2 of FIG. 6 (step S43). Immediately after that (e.g., after approximately several ns has elapsed), the light shutoff by the shutter 120 is cancelled and an optical signal is outputted to the outside (step S44).

Next, whether time t₁ has elapsed is determined (step S45).

If time t₁ has not elapsed (No in step S45), the wavelength tuning process moves to step S43 and the process in step S43 is performed again.

On the other hand, if time t₁ has elapsed (Yes in step 45), the current Iₜᵤₙₑ is controlled using the second current Iₜᵤₙₑ determination function calculated in step S2 of FIG. 6 (step S46).

Next, whether time t₂ has elapsed is determined (step S47).

If time t₂ has not elapsed (No in step S47), the wavelength tuning process moves to step S46 and the process in step S46 is performed again.

On the other hand, if time t₂ has elapsed (Yes in step 47), the wavelength tuning process is completed.

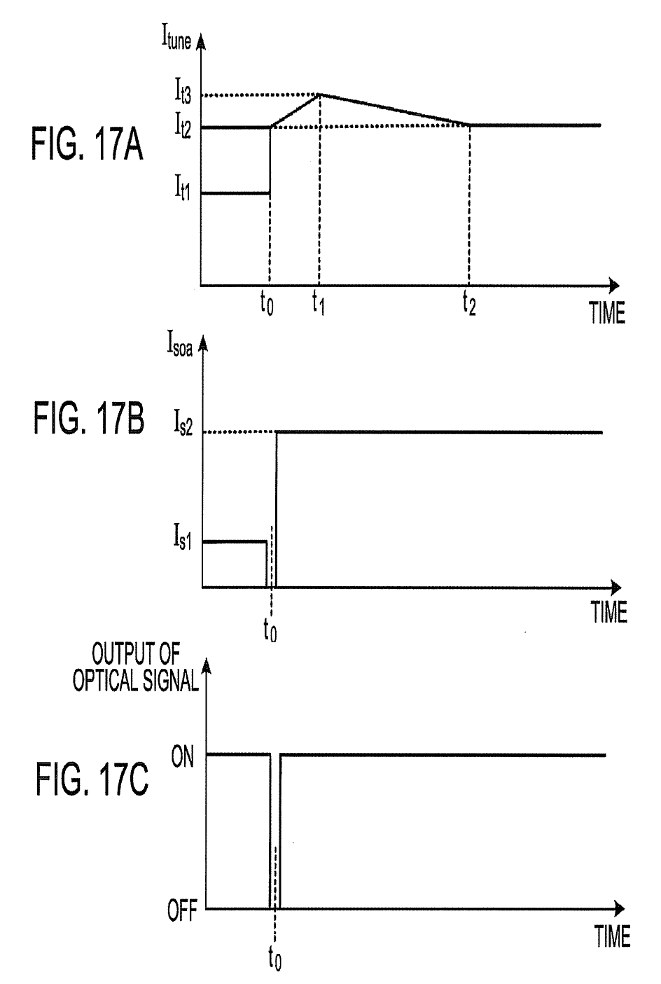

FIGS. 17A-17C include graphs schematically illustrating a result of control performed using the first control method according to the second embodiment.

If shutoff is performed using the SOA 121, the voltage Vsoa to be provided to the SOA 121 is set to 0V as illustrated in FIG. 17B before the control unit 12 performs control at time t₀ so that the current value of the current Iₜᵤₙₑ is changed from the current value Iₜ₁ to the current value Iₜ₂ as illustrated in FIG. 17A.

After the current value of the current Iₜᵤₙₑ is changed from the current value Iₜ₁ to the current value Iₜ₂, the current value of the current Iₛₒₐ to be provided to the SOA 121 is set to a current value I_{S2}, which is larger than a current value I_{S1}.

Thus, as illustrated in FIG. 17C, the output of an optical signal is shut off during a time when the voltage Vsoa is 0.

A variation in the temperature TLD and a variation in the wavelength in FIGS. 17A-17C are similar to those in the first control- method according to the first embodiment illustrated in FIGS. 8A-8D and are not illustrated.

Second Control Method

Next, a second method for controlling the optical module 10a will be described.

A function calculation process in the second method for controlling the optical module 10a is similar to the function calculation process in the second control method according to the first embodiment.

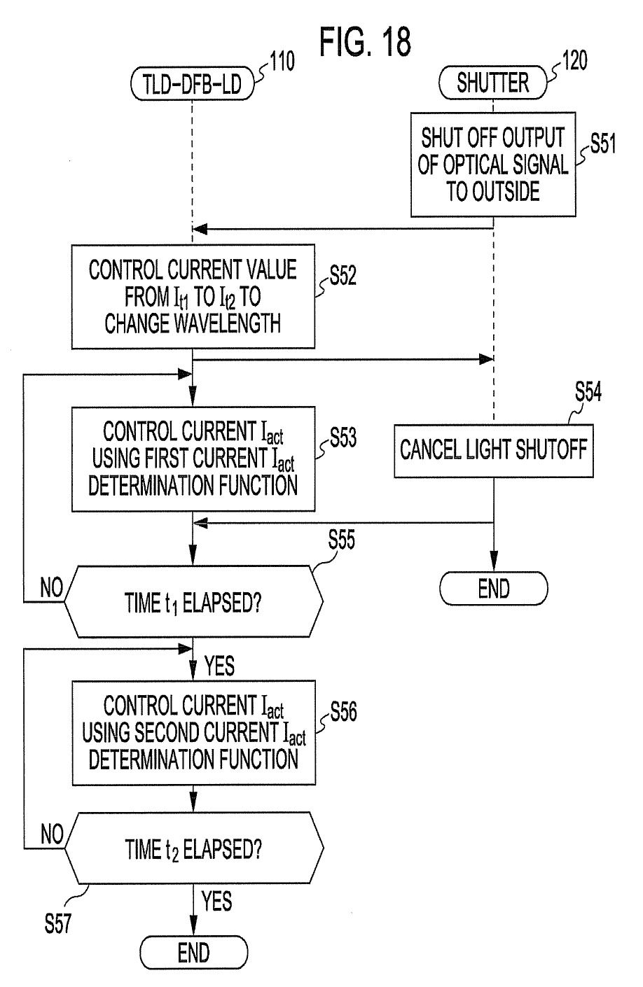

FIG. 18 is a flowchart illustrating a wavelength tuning process in the second method for controlling an optical module according to the second embodiment.

First, the control unit 12 controls the shutter 120 to shut off the output of an optical signal to the outside (step S51).

Next, the current Iₜᵤₙₑ is controlled from the current value Iₜ₁ to the current value Iₜ₂ to change the wavelength (step S52).

Next, the current I_{act} is controlled using the first current I_{act} determination function calculated in step S22 of FIG. 11 (step S53). Immediately after that (e.g., after approximately several ns has elapsed), the light shutoff by the shutter 120 is cancelled and an optical signal is outputted to the outside (step S54).

Next, whether time t₁ has elapsed is determined (step S55).

If time t₁ has not elapsed (No in step S55), the wavelength tuning process moves to step S53 and the process in step S53 is performed again.

On the other hand, if time t₁ has elapsed (Yes in step 55), the current I_{act} is controlled using the second current I_{act} determination function calculated in step S22 of FIG. 11 (step S56).

Next, whether time t₂ has elapsed is determined (step S57).

If time t₂ has not elapsed (No in step S57), the wavelength tuning process moves to step S56 and the process in step S56 is performed again.

On the other hand, if time t₂ has elapsed (Yes in step 57), the wavelength tuning process is completed.

If the shutter 120 shuts off light using the SOA 121, a variation in power caused when the current I_{act} is controlled is compensated for using the current Iₛₒₐ.

Specifically, if the proportionality factor of the current I_{act} with respect to power is represented by “a” and the proportionality factor of the current Iₛₒₐ with respect to power is represented by “b,” a relation illustrated in Formula 5 below exists.

I_{S3}−I_{S2}=a/b(Iₐ₁−Iₐ₁ₐ) Formula 5

Therefore, a variation in power caused when the current I_{act} is controlled is compensated for using the current Iₛₒₐ by previously calculate a/b and controlling a current I_{S3} 50 that Formula 5 is met.

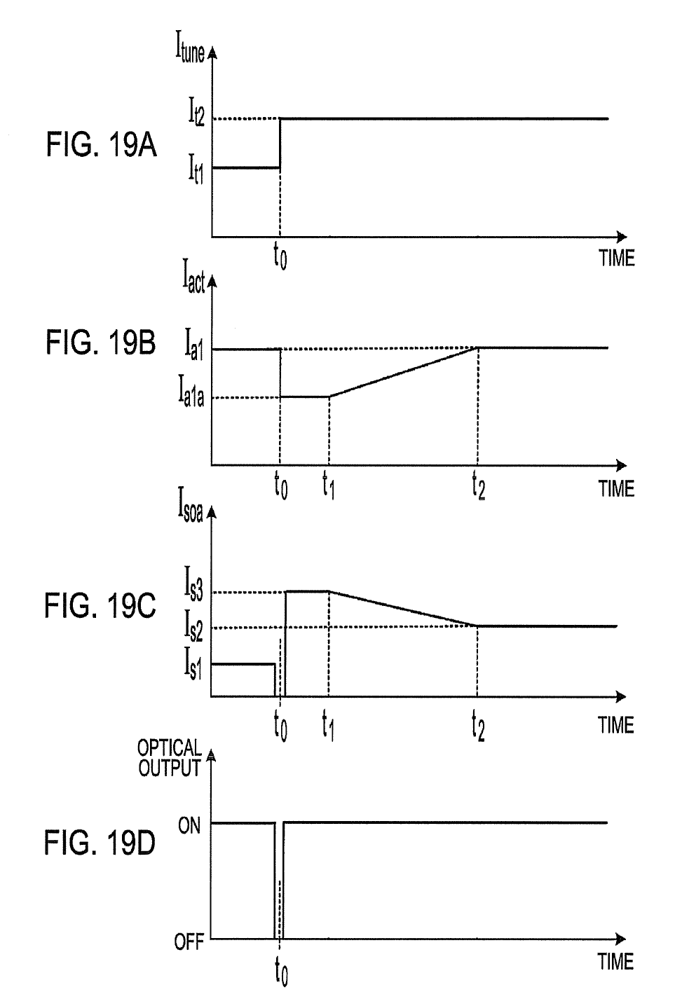

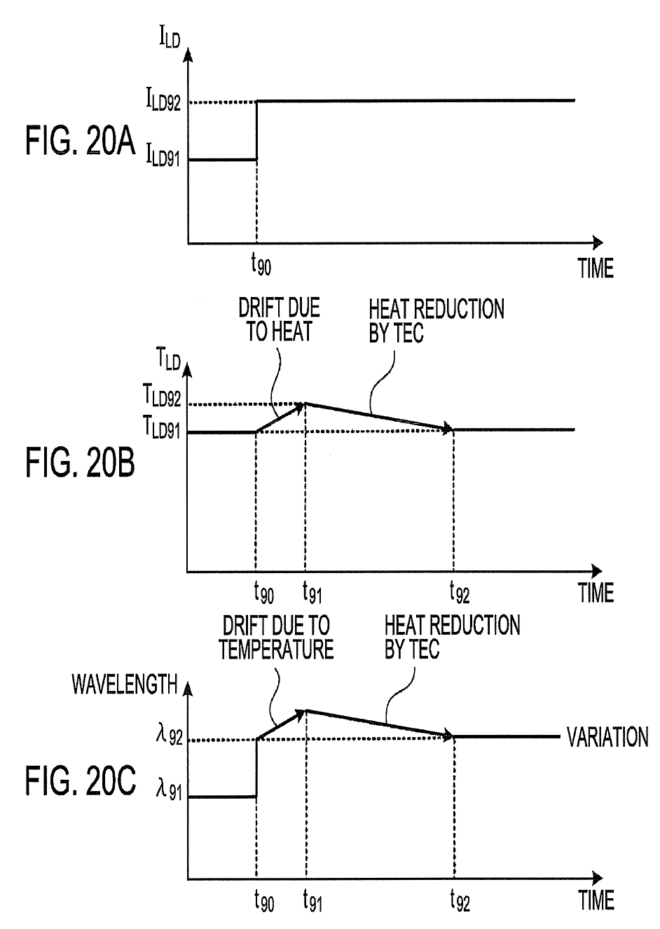

FIGS. 19A-19D include graphs schematically illustrating a result of control performed using the second control method according to the second embodiment.

The control of the current Iₜᵤₙₑ illustrated in FIG. 19A and the control of the current I_{act} illustrated in FIG. 19B is similar to that in the second control method according to the first embodiment illustrated in FIGS. 13A-13D.

In the case of the second control method according to this embodiment, if shutoff is performed using the SOA 121, the current value of a current to be provided to the SOA 121 is set to a current value I_{S3} larger than the current value I_{S2} so that Formula 5 is met, as illustrated in FIG. 19C after the current value of the current Iₜᵤₙₑ is changed from the current value Iₜ₁ to the current value Iₜ₂. Thus, a reduction in current value of the current I_{act} is compensated for.

In FIG. 19A-19D, a variation in the temperature TLD and a variation in the wavelength are similar to those in the second method according to the first embodiment illustrated in FIGS. 13A-13D and are not illustrated.

By adopting the optical module 10a according to the second embodiment, an advantage similar to that of the optical module 10 according to the first embodiment is obtained.

Also, by adopting the optical module 10a according to the second embodiment, wavelength switching is performed without affecting other channels in operation.

While the semiconductor laser control method and semiconductor laser control apparatus according to the present invention have been described on the basis of the illustrated embodiments, the invention is not limited thereto. Each component can be replaced with an arbitrary component having a similar function. Also, other arbitrary components or steps may be added to the present invention.

Also, the present invention may be combinations of arbitrary two or more components (features) of the above-mentioned embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical module comprising:
a semiconductor laser for output light with a wavelength;
a temperature stabilization unit arranged for adjusting temperature of the semiconductor laser; and
a controller for controlling a current injected to the semiconductor leaser by the use of a first function in accordance with changing of the wavelength on the bases of heat at the time of changing of the wavelength of the outputted light of the semiconductor leaser in a predetermined first period, and controlling the current injected to the semiconductor leaser by the use of a second function in accordance with changing of the wavelength on the bases of the temperature stabilization unit in a predetermined second period after the first period.

2. The optical module of claim 1, further comprising a shutter for shutting off light from the semiconductor laser.

3. The optical module of claim 1, wherein the elector absorption modulator includes an absorption layer for shutting off light from the semiconductor laser in order to be controlled a semiconductor optical amplifier control voltage of the semiconductor optical amplifier.

4. The optical module of claim 2, wherein the shutter includes:
a semiconductor optical amplifier driven by a wavelength control current for controlling a wavelength of the semiconductor laser and a gain control current for controlling a gain of the semiconductor laser from the controller; and
a semiconductor optical amplifier compensates a power variation of the light from the semiconductor laser in accordance with an injection amount of the gain control current.

5. The optical module of claim 1, further comprising a memory for storing wavelength variation values of the semiconductor laser on the bases of the injection amounts of the wavelength control current from the controller to the semiconductor laser.

6. A control method for optical module including a semiconductor laser for output light with a wavelength and a temperature stabilization unit arranged for adjusting temperature of the semiconductor laser, the control method comprising:
controlling a current injected to the semiconductor leaser by the use of a first function in accordance with changing of the wavelength on the bases of heat at the time of changing of the wavelength of the outputted light of the semiconductor leaser in predetermined first interval; and
controlling the current injected to the semiconductor leaser by the use of a second function in accordance with changing of the wavelength on the bases of the temperature stabilization unit in predetermined second interval after the first interval.

7. The control method of claim 6:
wherein the semiconductor laser is driven by a wavelength control current and a gain control current;
wherein the first function and the second function are for the wavelength control current and for controlling wavelength of the semiconductor leaser, respectively.

8. The control method of claim 7, wherein the first function and the second function include a first factor for injection amounts of the wavelength control current and a second factor for wavelength variation value on the bases of the injection amounts of the wavelength control current.

9. The control method of claim 8, wherein the wavelength variation value is in accordance with a carrier plasma effect by the injection of the wavelength control current and the variation in the temperature.

10. The control method of claim 7, wherein the first interval and the second interval are calculated from a thermal response characteristic by the injection of the wavelength control current.

11. The control method of claim 6:
wherein the semiconductor laser is driven by a wavelength control current for controlling a wavelength of the semiconductor laser and a gain control current for controlling a gain of the semiconductor laser;
wherein the first function and the second function for controlling the gain control current, respectively.

12. The control method of claim 11, wherein the first function and the second function control an injection amount of the gain control current in order to compensate a first variation of calorie on the bases of the injection amount of the gain control current in accordance with a second variation of calorie on the bases of injection amount of the wavelength control current, respectively.

13. The control method of claim 12, wherein the first function and the second function include:
a first factor for injection amounts of the wavelength control current,
a second factor for wavelength variation value of the semiconductor laser on the bases of the injection amounts of the wavelength control current, and
a third factor for wavelength variation value of the semiconductor laser on the bases of the injection amounts of the gain control current.

14. The control method of claim 13, wherein the wavelength variation value of the semiconductor laser of the injection amount of the wavelength control current and the gain control current are corresponded to a variation in the temperature of the semiconductor laser.

15. The control method of claim 12, further comprising simultaneously injecting the wavelength control current and the gain control current.

16. The control method of claim 6, further comprising shutting off light from the semiconductor before wavelength changing of the semiconductor laser.
